(19) United States
(12) Patent Application Publication
(10) Pub. No.: US 2004/0085860 A1
(43) Pub. Date: May 6, 2004

(54) Position detecting and correcting device for timepiece

(76) Inventor: Chih Hao Yiu, Taichung (TW)

Correspondence Address: CHARLES E. BAXLEY, 5th Floor, 59 John Street, New York, NY, 10038, US

(21) Appl. No.: 10/283,887

(22) Filed: Oct. 31, 2002

(51) Int. Cl. G04B 18/00; G04B 27/00

(52) U.S. Cl. 368/185

(57) ABSTRACT

A timepiece includes a reference wheel and one or more target wheels to be detected and corrected to the correct or standard time. The target wheels each includes a number of binary codes angularly spaced from each other, and each having a number of digits radially spaced from each other. The reference wheel includes a number of orifices angularly and radially spaced from each other, for moving over the digits of the binary codes and for determining the positions of the wheels by moving the orifices of the reference wheel relative to the digits of the binary codes.

### BACKGROUND OF THE INVENTION

1. Field of the Invention

The present invention relates to a timepiece, and more particularly to a timepiece including a device for detecting and correcting the relative positions of rotary members and/or hands thereof.

2. Description of the Prior Art

Various kinds of typical timepieces have been developed, and may be used for automatically setting or detecting or correcting the time or the rotary members or the hands thereof. In addition, the various kinds of typical timepieces may be used for receiving the time signals from the National Bureau of Standards (NBS), the radio stations, or the like, and may correct or set the time accordingly.

U.S. Pat. No. 4,117,661 to Bryant, Jr., and U.S. Pat. No. 4,204,398 to Lemelson disclose two of the typical timepieces, and comprise a complicated electric circuit for detecting and/or decoding and/or correcting the time of the timepieces.

U.S. Pat. No. 4,358,753 to Cascini, U.S. Pat. No. 5,566,140 to Kohata et al., U.S. Pat. No. 5,640,007 to Talbott et al., and U.S. Pat. No. 5,930,205 to Baba et al. disclose the other four typical timepieces, and each may include a number of illumination devices, scanning devices, photo elements for emitting and receiving lights respectively, to detect and to correct the positions of the wheels and/or hands.

In most of the typical timepieces, a number of rotary wheels are required to be provided and coupled between the hands and the motors, such as the step motors, for allowing the hands to be rotated or driven by the motors. The rotary wheels each may include one or more holes or orifices, and the holes or orifices of all of the three rotary wheels should be aligned with each other for allowing the lights generated by the light or illumination devices to be emitted through the holes or orifices of the rotary wheels.

Accordingly, a complicated mechanism or device or configuration is required to be provided for detecting or determining whether the holes or orifices are aligned with each other. The light may only be emitted through the holes or orifices of the rotary wheels by chance.

U.S. Pat. No. 5,231,612 to Allgaier et al. discloses a further typical timepiece including a reflex barrier or a detecting device disposed on one side of a number of wheels, and having a sending part and a receiving part, and a rear mirror disposed on the other side of the wheels.

The wheels of the typical timepieces each includes a number of holes or orifices formed therein for receiving the lights emitted by the illumination device. The holes of the wheels should be aligned with each other for allowing the light to emit through the holes of the wheels simultaneously, and for allowing the lights to be reflected to the receiving parts of the detecting device.

However, it may take a long time before the holes of the wheels may be aligned with each other. For some of the typical timepieces, it may take twelve hours or even twenty four hours for allowing the holes of the wheels to be aligned with each other, and for allowing the light to emit through the holes of the wheels simultaneously.

Particularly, the first wheel that faces the reflex barrier includes a reflective wheel disk disposed thereon for reflecting the light generated by the light devices. The reflective wheel disk includes a single hole for allowing the light to emit through the hole of the reflective wheel disk. However, no other devices or mechanisms may be provided for positively determining or locating the hole of the reflective wheel disk, such that the timepiece may not readily know whether the light has been aligned with the hole of the reflective wheel disk or not, and should determine the alignment of the hole of the reflective wheel disk with the reflex barrier with try and error methods.

U.S. Pat. No. 4,700,062 to Ernst discloses a further timepiece including a reference mark for determining the zero point of an incremental scale, and for being aligned or scanned through the corresponding scanning aperture of the scanning plate.

However, similarly, the wheels or plates should all include a number of holes provided therein. In addition, a number of illumination devices are required to be provided for generating lights through various holes or orifices of the wheels or plates. Furthermore, the timepiece also should determine the alignment of the hole of the reflective wheel disk with the illumination device with try and error methods.

The present invention has arisen to mitigate and/or obviate the afore-described disadvantages of the conventional timepieces.

### SUMMARY OF THE INVENTION

The primary objective of the present invention is to provide a timepiece including a simplified device or configuration for detecting and correcting the relative positions of rotary members and hands of the timepiece.

The other objective of the present invention is to provide a timepiece including an initializing or starting code for positively determining the aperture of the first rotary member and thus for easily and readily detecting and correcting the relative positions of rotary members and hands of the timepiece.

The further objective of the present invention is to provide a timepiece including a binary code series arranged in a circle on or around a rotary member for determining the relative position between the rotary members.

In accordance with one aspect of the invention, there is provided a timepiece comprising a first target wheel including a plurality of binary codes provided thereon, and angularly spaced from each other, the binary codes each including a plurality of digits radially spaced from each other, a reference wheel including a detecting code having a plurality of orifices formed therein and angularly spaced from each other and radially spaced from each other, for moving over the digits of the binary codes of the first target wheel respectively, and means for determining positions of the reference wheel and the first target wheel by moving the orifices of the reference wheel relative to the digits of the binary codes.

The determining means includes a light emitting device to generate a light through the orifices of the reference wheel and onto the digits of the binary codes.

The digits of the binary codes include and represent “0” and “1” signals respectively, the first target wheel includes a plurality of apertures formed therein and at positions representing the “1” signals of the binary codes respectively.

The determining means includes a light receiving device to receive the light generated by the light emitting device and emitted through the orifices of the reference wheel and the apertures of the first target wheel.

A device may be provided for driving the reference wheel, and/or for driving the first target wheel simultaneously or separately or individually.

The reference wheel includes sixty binary codes each having six digits radially spaced from each other for representing sixty minutes of time.

A device may further be provided for locating the orifices of the reference wheel, and includes a starting code provided on the reference wheel to determine positions of the orifices of the reference wheel.

The starting code may include such as at least seven holes formed in the reference wheel to provide seven consecutive “1” signals and to determine the position of the reference wheel and thus the positions of the orifices of the reference wheel.

The reference wheel includes an opening formed therein, the timepiece further includes a second target wheel aligned in the opening of the reference wheel, the second target wheel includes a plurality of binary codes provided thereon, and angularly spaced from each other, the binary codes each includes a plurality of digits radially spaced from each other, the detecting code of the reference wheel includes a plurality of orifices formed therein and angularly spaced from each other and radially spaced from each other, for moving over the digits of the binary codes of the second target wheel respectively.

Further objectives and advantages of the present invention will become apparent from a careful reading of a detailed description provided hereinbelow, with appropriate reference to accompanying drawings.

### BRIEF DESCRIPTION OF THE DRAWINGS

FIG. 1 is a partial exploded view of a timepiece in accordance with the present invention;

FIG. 2 is an upper planer view of a target wheel, such as a minute wheel, of the timepiece;

FIG. 3 is an upper planer view of another target wheel, such as an hour wheel, of the timepiece;

FIG. 4 is an upper planer view of a reference wheel, such as a second wheel, of the timepiece;

FIG. 5 is a partial side schematic view of the timepiece;

FIG. 6 is another partial exploded view of the timepiece;

FIGS. 7A, 7B, 7C, 7D, 7E, 7F are partial exploded views illustrating the operation or the detection of the rotary wheels of the timepiece; and

FIG. 7G is a a diagram illustrating the signals received by the signal receiving device of the detecting device.

### DETAILED DESCRIPTION OF THE PREFERRED EMBODIMENT

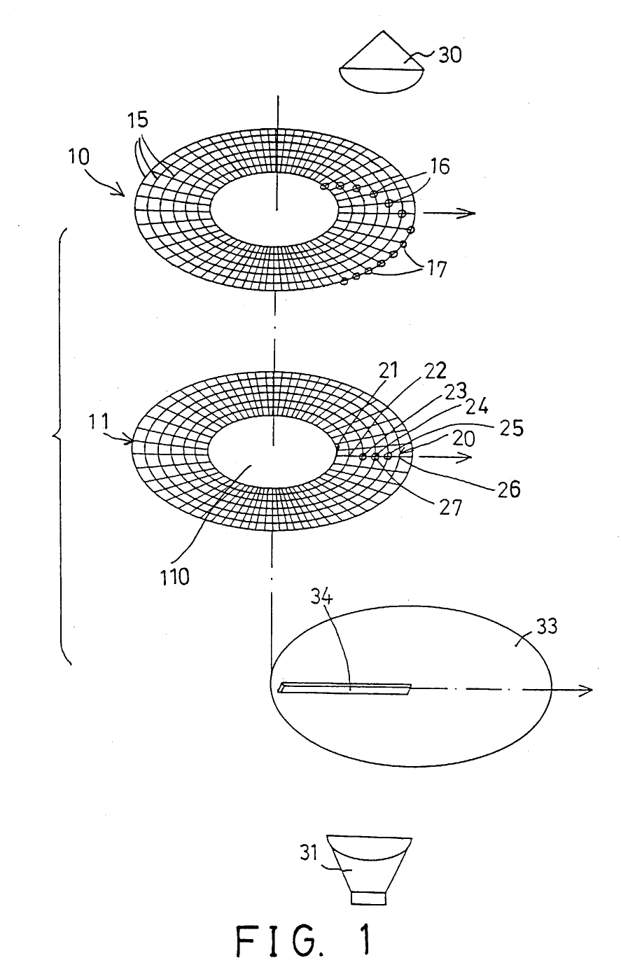

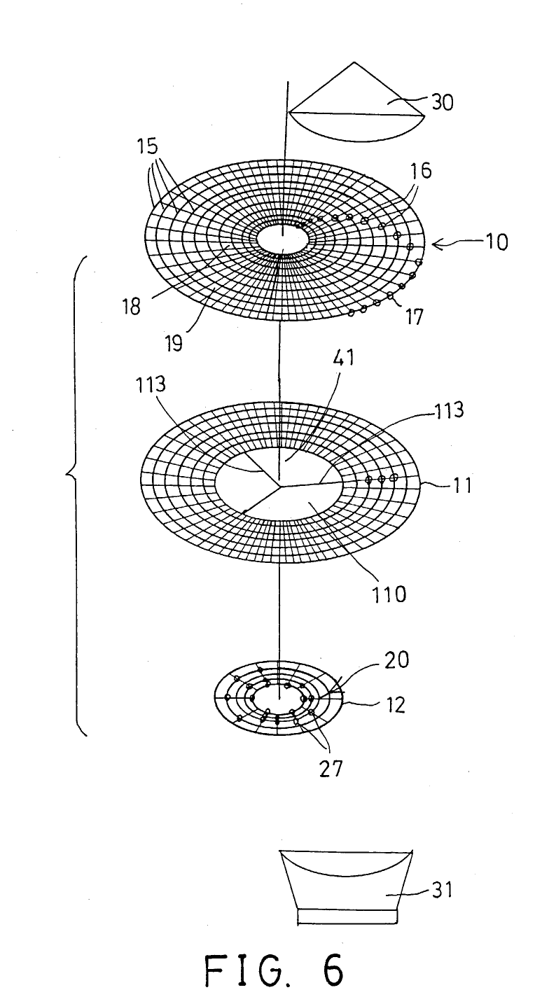

Referring to the drawings, and initially to FIGS. 1-5, a timepiece in accordance with the present invention comprises a reference wheel 10 which may be either a second, a minute, or an hour wheel, but preferably a second wheel (FIGS. 1, 4, 6), and one or more target wheels 11, 12 which may also be either an hour wheel, a minute wheel, or a second wheel, but preferably a minute wheel 11 (FIGS. 1, 2, 6) and an hour wheel 12 (FIGS. 3, 6) respectively.

As best shown in FIG. 5, the reference wheel 10 and the target wheels 11, 12 may be rotatably supported on a supporting board 33 of a timepiece housing (not shown) with shafts 43, 41, 42 respectively, and coupled to hands 46, 44, 45 respectively, and thus rotated in concert with the hands 46, 44, 45 respectively, for allowing the wheels 10, 11, 12 to be rotated independently and to be rotated relative to each other.

Two driving devices 53, 50, such as two step motors 53, 50 are provided and coupled to the reference wheel 10 and the target wheels 11 and/or 12 respectively with gear couplings 54; and 51, 52 respectively, or with the other or similar transmission couplings, for allowing the reference wheel 10 and the target wheels 11, 12 to be rotated or driven by the step motors 53, 50 separately or independently.

For example, the driving device 53 may be coupled to the reference wheel 10 with the gear coupling 54, for rotating and driving the reference wheel 10. The other driving device 50 may be coupled to the minute or target wheel 11 with the gear coupling 51, for rotating and driving the minute or target wheel 11. The gear coupling 52 may be coupled between the target wheels 11, 12 for allowing the hour target wheel 12 to be rotated or driven by the driving device 50.

The timepiece in accordance with the present invention is to provide a mechanism or an arrangement to readily or quickly determine the relative or positive positions of the reference wheel 10 and the target wheels 11, 12. The supporting board 33 includes one or more grooves 34 formed therein for light receiving or guiding purposes. A processor device 70 may be attached onto the supporting board 33 for processing or controlling the operation of the timepiece.

A detecting device 30, 31 includes a light emitting part or device 30 for generating lights, and a light receiving part or device 31 for receiving the lights or the reflective lights. It is to be noted that timepiece in accordance with the present invention requires only a single light emitting device 30 and a single light receiving device 31 that are good enough to determine the relative or positive positions of the reference wheel 10 and the target wheels 11, 12 and the hands 44-46.

FIG. 1 illustrates a simplified or a partial arrangement for clearly showing or illustrating the detecting or correcting or determining of the relative or positive positions of or between the reference wheel or the second wheel 10 and the target wheel or the minute wheel 11.

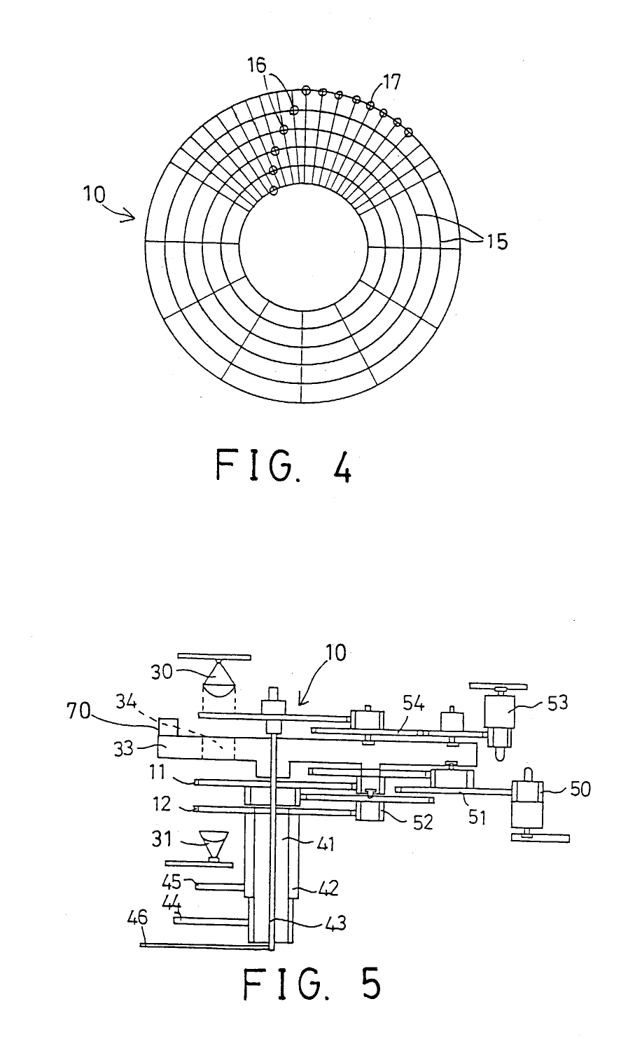

For example, as shown in FIGS. 1 and 4, the reference wheel 10 includes an initializing or starting code or device having such as seven holes 17 consecutively formed in the outer peripheral portion or circle of the reference wheel 10, and uniformly and angularly spaced from each other, such as spaced from each other for 6°, for receiving the light generated by the light emitting device 30 of the detecting device 30, 31.

The reference wheel 10 further includes a series of testing codes or orifices 16 formed therein for allowing the light to emit therethrough. The orifices 16 of the reference wheel 10 are also uniformly and angularly spaced from each other, such as spaced from each other for 6°, and radially spaced away from each other. For example, the orifices 16 of the reference wheel 10 are arranged on the six concentric circles 15 that are equally spaced from each other.

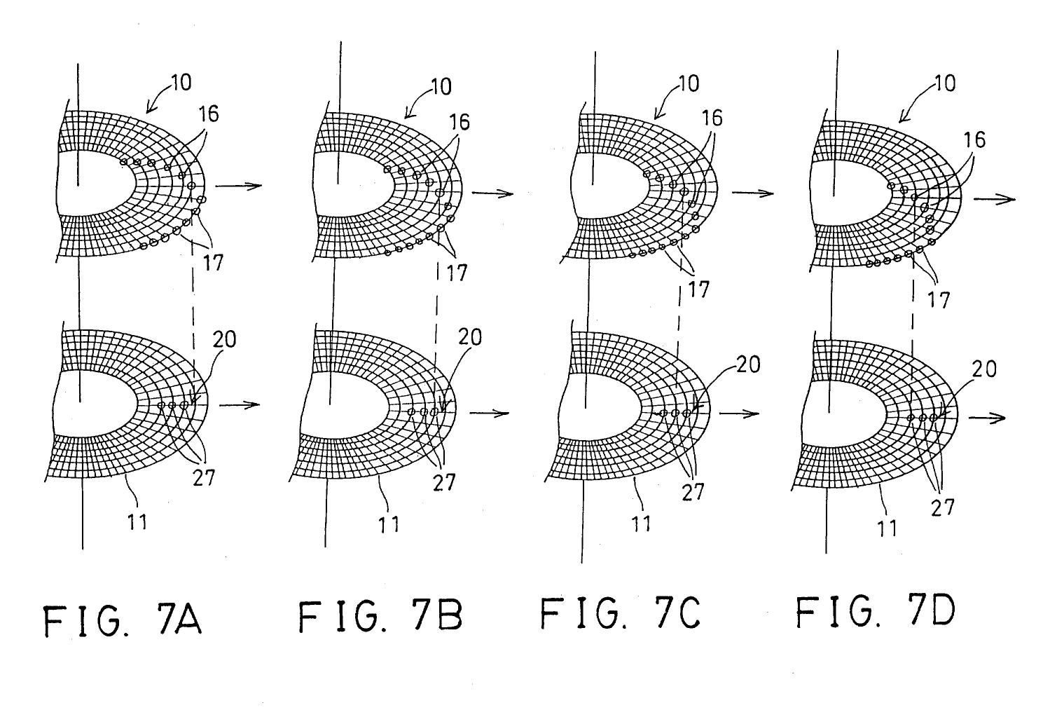

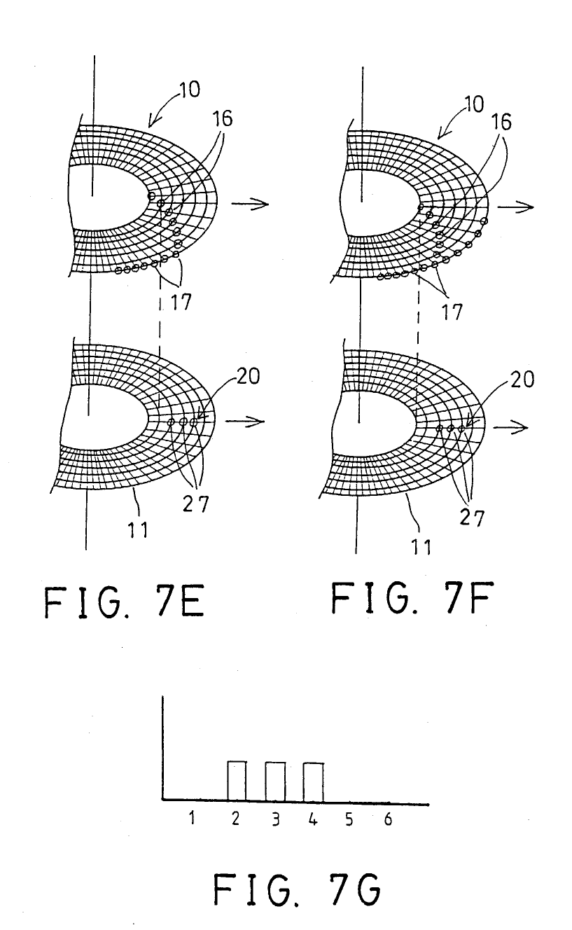

One of the testing codes or orifices 16, or the outer orifice 16 may be arranged in one of the outer circles 15 or the peripheral portion of the reference wheel 10 or may be aligned with or arranged in the same circle of the holes 17 of the starting code (FIG. 4). However, preferably, the holes 17 of the starting code are arranged in a circle further radially outward of the circles 15 for the orifices 16 of the reference wheel 10 (FIGS. 1, 7A-7F).

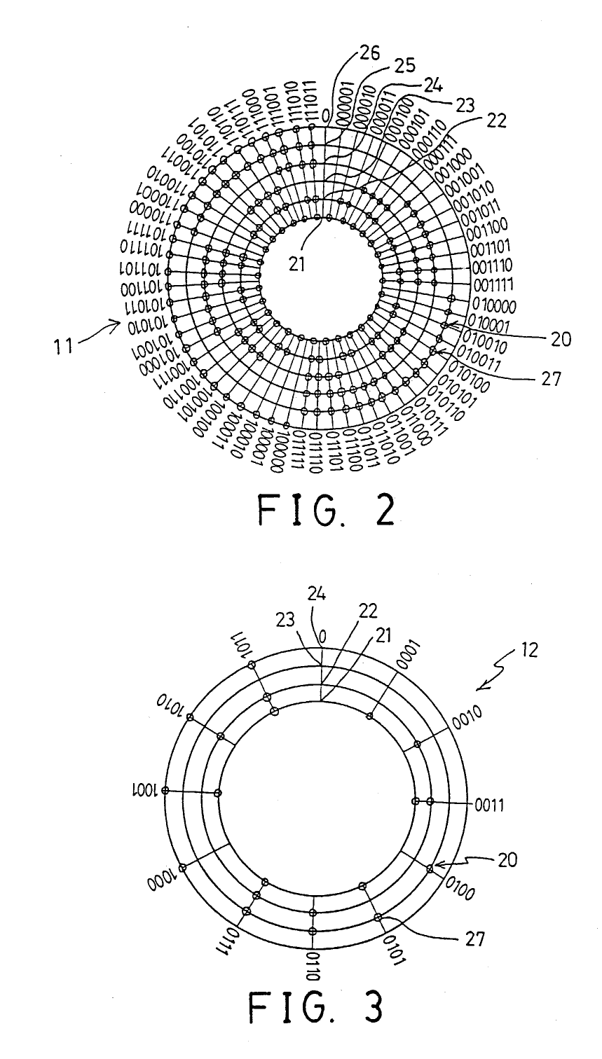

As best shown in FIG. 2, the target wheel or the minute wheel 11 includes a series or a number of binary codes 20 arranged on the target wheel 11 and uniformly and angularly spaced from each other, such as spaced from each other for 6°, and radially spaced away from each other, such that sixty binary codes 20 may be arranged on the target wheel 11 for representing the sixty (60) minutes respectively.

The sixty binary codes 20, that represent the sixty (60) minutes respectively, each includes six digits 21, 22, 23, 24, 25, 26, arranging from 000000 to 111011. The six digits 21-26 of the binary codes 20 are radially spaced from each other, or are arranged on the six concentric circles that are radially spaced from each other, preferably with equally spaced distances.

The binary codes 20 of six digits may include or represent a series of decimal numbers from 0 to 64, and thus are good enough to represent the sixty (60) minutes respectively. The respective digits 21-26 of the binary codes 20 that represent “1” are formed with apertures 27 therein, for receiving the light generated by the light emitting device 30 of the detecting device 30, 31, and for allowing the light receiving device 31 to receive the light passing through the apertures 27 of the target wheel 11.

The binary code “000000” that represents the “0” decimal numeral is preferably arranged or located at the position of “0” or “12” o'clock; or “0” or “60” minute or second, etc., but may also be arranged or located at the other positions, such as the “1”, “2”, “3”, . . . o'clock position, the “5”, “6”, “10”, . . . minute or second position, etc.

Similarly, when either of the binary codes 20 has been detected or determined, the angular position of the target wheel 11 relative to the timepiece housing or the clock face (not shown) may then be determined. The processor device 70 may memorize any or all of the binary codes 20, and may thus determine the angular position of the target wheel 11 relative to the clock face when the location of either of the binary codes 20 has been determined.

Similarly, as shown in FIGS. 3, 6, illustrated is the target or hour wheel 12 which includes only twelve (12) binary codes 20 angularly disposed or formed thereon and angularly and equally spaced for 30° from each other, for representing the twelve (12) o'clock numerals or time. The binary codes 20 require only four (4) digits 21-24 that may represent a series of decimal numbers from 0 to 16 and that are good enough to represent the twelve (12) o'clock numerals or time.

Similarly, the respective digits 21-24 of the binary codes 20 that represent “1” are also formed with apertures 27 therein, for receiving the light generated by the light emitting device 30 of the detecting device 30, 31, and for allowing the light receiving device 31 to receive the light passing through the apertures 27 of the target wheel 12.

As shown in FIGS. 1 and 6, the light emitting device 30 of the detecting device 30, 31 is arranged above the wheels 10, 11, particularly disposed above the side or the peripheral portion of the wheels 10, 11 that have the binary codes 20 provided therein, for emitting the light through the orifices 16 of the reference wheel 10 and the apertures 27 of the target wheel 11.

The light receiving device 31 of the detecting device 30, 31 is arranged below the side or the peripheral portion of the wheels 10, 11 for receiving the light passing through the orifices 16 of the reference wheel 10 and the apertures 27 of the target wheel 11. Pulse signals may be received or determined by the light receiving device 31 and sent to the processor device 70 when the light receiving device 31 receives the light, as shown in steps 2-4 of FIG. 7G.

The reference wheel 10 and the target wheel 11 may be- rotated or driven by the driving devices 53, 50 respectively, for allowing the orifices 16 and the holes 17 of the reference wheel 10 and/or the apertures 27 of the binary codes 20 of the target wheels 11, 12 to be moved through the detecting device 30, 31 in sequence.

The processor device 70 may be coupled to the light emitting device 30 and the light receiving device 31 of the detecting device, for actuating the light emitting device 30 to emit the light, and for receiving the signals, such as the pulse signals from the light receiving device 31, and may be coupled to the driving devices 53, 50 for actuating or controlling the driving devices 53, 50 to rotate or to drive the wheels 10-12 respectively.

The reference wheel 10 and the target wheels 11, 12 are preferably made of the materials that may not reflect the lights, such as the plastic or synthetic materials, for allowing the light to emit through the orifices 16 and the holes 17 of the reference wheel 10 and/or the apertures 27 of the binary codes 20 of the target wheels 11, 12.

Alternatively, or similarly, the target wheels 11, 12 may include a number of reflective members (not shown) attached onto the positions of the apertures 27 thereof, for reflecting the light through the orifices 16 and the holes 17 of the reference wheel 10, and back to a light receiving device 31 that is disposed beside the light emitting device 30.

As also shown in FIG. 2, the six digits 21-26 of the binary codes 20 are arranged from the radially inward position toward the radially outward position. However, on the contrary, the six digits 21-26 of the binary codes 20 may also be arranged from the radially outward position toward the radially inward position instead.

For example, the three apertures 27 of the binary code 20 of the target wheel 11 as shown in FIGS. 7A-7F may be the binary code 20 “011100” or “001110”. However, for clearly illustrating purposes, the binary code 20 as shown in FIGS. 7A-7F is determined as the binary code 20 “011100” corresponding to the binary code 20 “011100” as shown in FIG. 2, that represent the twenty eight (28) minute or second of the time.

When the target wheel 11 is a minute wheel, the target wheel 11 will be rotated for only 6° in one minute. The reference wheel 10 is preferably the second wheel and may be rotated for one round in one minute, such that the reference wheel 10 will be rotated in one round relative to the target wheel 11 in one minute.

As shown in FIGS. 1, 6 and 7A-7F, the starting code or holes 17 of the reference wheel 10 are preferably arranged or disposed at the position offset or radially outward from the outer peripheral portion of the target wheel 11, for allowing the light to emit through the holes 17 of the reference wheel 10 and to bypass the target wheel 11, and to the light receiving device 31.

It is to be noted that the binary codes 20 each may include up to six (6) digits 21-26 only, such that, at most, only six (6) consecutive signals may be received by the light receiving device 31. Accordingly, when the light receiving device 31 has received the seven (7) consecutive signals via the seven (7) holes 17 of the starting code, the position of the reference wheel 10 and thus the positions of the orifices 16 of the reference wheel 10 may be determined.

In operation, as shown in FIGS. 7A-7F, illustrated is an example for detecting the binary code 20 “011100” which represent the twenty eight (28) minute or second of the time. The orifices 16 of the reference wheel 10 is provided and arranged for detecting the six digits 21-26 of the binary codes 20 in series, from the first digit 26.

As shown in FIG. 7A, when the binary code 20 “011100” is arranged or disposed above the light receiving device 31 (FIG. 1), and when the first digit or the first orifice 16 of the testing code of the reference wheel 10 is aligned with the first digit 26 of the binary code 20 where no aperture 27 is formed therein, the light receiving device 31 will not receive any signal, and may have an “off” signal as shown in step 1 of FIG. 7G.

As shown in FIG. 7B, when the second orifice 16 of the testing code of the reference wheel 10 is aligned with the second digit 25 of the binary code 20 where an aperture 27 is formed therein, the light receiving device 31 will receive a light or a signal, such as a pulse or an “on” signal, as shown in step 2 of FIG. 7G.

Similarly, as shown in FIGS. 7C-7F, when the other orifices 16 of the testing code of the reference wheel 10 are aligned with the other digits 24-21 of the binary code 20 where two apertures 27 are formed therein, the light receiving device 31 will receive the pulse or “on” signals and two “off” signals as shown in steps 3-6 of FIG. 7G, such that the binary code 20 “011100” may be detected, and the twenty eight (28) minute or second position of the target wheel 11 may thus be detected and determined.

It is to be noted that the seven (7) holes 17 of the starting code may be separated or angularly spaced from the orifices 16 of the reference wheel 10. Once the seven consecutive signals have been detected by the light receiving device 31 via the seven holes 17 of the reference wheel 10, the processor device 70 may actuate the driving device 53 to quickly rotate the reference wheel 10 to align the orifices 16 of the reference wheel 10 with the binary code 20 “011100”.

The seven (7) or more holes 17 have been shown and provided in the reference wheel 10 to form as the starting code, or to form the means for determining the position of the orifices 16 of the reference wheel 10 and for determining the movement of the orifices 16 of the reference wheel 10 over the apertures 27 of the binary codes 20 of the target wheel 11. However, it is to be noted that, the other starting code may also be provided for determining the position of the reference wheel 10, and will be filed in the other co-pending applications.

The receiver device 70 may include a signal receiver part or member to receive the time signals from the National Bureau of Standards (NBS), the radio stations, or the like. After the positions of the reference wheel 10 and the target wheels 11, 12 have been determined, the processor device 70 may then actuate the driving devices 53, 50 to quickly rotate the wheels 10, 11 and the hands 46, 44 to the time received by the signal receiver member. The timepiece may thus be easily and quickly corrected to the correct or standard time.

It is to be noted that the reference wheel 10 is only required to be rotated relative to the target wheel 11 for 6×6=36° only, for allowing the six orifices 16 thereof to move over the binary code 20 “011100”, such that the positions of the reference wheel 10 and the target wheel 11 may be detected and determined within about thirteen (13) seconds which include the six (6) orifices 16 and the seven (7) or more consecutive holes 17 of the reference wheel 10.

The timepiece thus includes a greatly simplified configuration having only one detecting device. In addition, the relative or positive positions of the reference wheel 10 and the target wheel 11 may be easily and quickly and precisely and definitely detected and determined within few seconds.

Normally, the error or the time is normally within few seconds. The determination of the relative position between the reference wheel 10 and the target wheel 11 is good enough to detect and to correct the timepiece to the correct or standard time. However, when the timepiece is to be initialized or started after a long time or right after the timepiece is purchased, the hour target wheel 12 (FIGS. 3, 6) may further be required to be detected and corrected.

As shown in FIG. 6, the hour target wheel 12 may further be provided and arranged or aligned with a center opening 110 of the target wheel 11, and rotatable relative to the target wheel 11 which may be secured to the shaft 41 thereof with one or more ribs 113 or the like. The ribs 113 are arranged to be offset or separated from the apertures 27 of the target wheel 12, for preventing the apertures 27 of the target wheel 12 from being blocked by the ribs 113.

In the arrangement as shown in FIG. 6, the reference wheel 10 may include four orifices 16 arranged in the radially inner portion 18 thereof to detect the binary codes 20 of the hour or smaller target wheel 12, and six further orifices 16 arranged in the radially outer portion 19 thereof to detect the binary codes 20 of the minute or greater target wheel 11. The relative or positive positions of the reference wheel 10 and the target wheels 11, 12 may thus be easily and quickly and precisely and definitely detected and determined within about seventeen (17) seconds.

It is further to be noted that, for simplifying purposes, the binary codes 20 of the target wheel 11 may each include only five, four, or fewer digits that are angularly spaced away from each other for greater angles. The relative or positive positions of the reference wheel 10 and the target wheels 11, 12 may also be easily and quickly, but relatively roughly detected and determined with the binary codes 20 having fewer digits.

Accordingly, the timepiece in accordance with the present invention includes a simplified device or configuration for detecting and correcting the relative positions of rotary members and hands of the timepiece, and includes an initializing or starting code for positively determining the orifices or the detecting code of the reference wheel, and includes a binary code sequence provided on the target wheel for easily and readily detecting and correcting the relative positions of rotary members and hands of the timepiece.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A timepiece comprising:
a first target wheel including a plurality of binary codes provided thereon, and angularly spaced from each other, said binary codes each including a plurality of digits radially spaced from each other,
a reference wheel including a detecting code having a plurality of orifices formed therein and angularly spaced from each other and radially spaced from each other, for moving over said digits of said binary codes of said first target wheel respectively, and
means for determining positions of said reference wheel and said first target wheel by moving said orifices of said reference wheel relative to said digits of said binary codes of said first target wheel.

2. The timepiece according to claim 1, wherein said determining means includes a light emitting device to generate a light through said orifices of said reference wheel and onto said digits of said binary codes.

3. The timepiece according to claim 2, wherein said digits of said binary codes include and represent “0” and “1” signals respectively, said first target wheel includes a plurality of apertures formed therein and at positions representing said “1” signals of said binary codes respectively.

4. The timepiece according to claim 3, wherein said determining means includes a light receiving device to receive the light generated by said light emitting device and emitted through said orifices of said reference wheel and said apertures of said first target wheel.

5. The timepiece according to claim 1 further comprising means for driving said reference wheel.

6. The timepiece according to claim 1 further comprising means for driving said first target wheel.

7. The timepiece according to claim 1, wherein said reference wheel includes sixty binary codes each having six digits radially spaced from each other for representing sixty minutes of time.

8. The timepiece according to claim 1 further comprising means for locating said orifices of said reference wheel.

9. The timepiece according to claim 8, wherein said locating means includes a starting code provided on said reference wheel to determine positions of said orifices of said reference wheel.

10. The timepiece according to claim 9, wherein said starting code includes at least seven holes formed in said reference wheel.

11. The timepiece according to claim 1, wherein said reference wheel includes an opening formed therein, said timepiece further includes a second target wheel aligned in said opening of said reference wheel, said second target wheel includes a plurality of binary codes provided thereon, and angularly spaced from each other, said binary codes each includes a plurality of digits radially spaced from each other, said detecting code of said reference wheel includes a plurality of orifices formed therein and angularly spaced from each other and radially spaced from each other, for moving over said digits of said binary codes of said second target wheel respectively.
